(19) United States
(12) Patent Application Publication
(10) Pub. No.: US 2006/0109901 A1
(43) Pub. Date: May 25, 2006

(54) System and method for drift-free fractional multiple description channel coding of video using forward error correction codes

(75) Inventors: Jong Chul Ye, Clifton Park, NY (US); Yingwei Chen, Briarciff Manor, NY (US)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Eindhoven (NL)

(21) Appl. No.: 10/538,566

(22) PCT Filed: Dec. 10, 2003
(86) PCT No.: PCT/IB03/05870

§ 371 Date: Jun. 15, 2005

Related U.S. Application Data
(60) Provisional application No. 60/434,548, filed on Dec. 19, 2002.

(51) Int. Cl. H04N 7/12; H04N 11/04; H04B 1/66; H04N 11/02

(52) U.S. Cl. 375/240.08; 375/240.2; 375/240.27

(57) ABSTRACT

A system and method are disclosed that provide an improved encoding scheme where input video is encoded into a base layer and a enhancement layer according to a fine-granular scalability coding to generate a plurality of equal priority descriptions, then the generated descriptions are decoded by a decoder. The plurality of equal priority partitions is comprised of partitions generated from the base and enhancement layers and a forward error correction (FEC) code according to predetermined criteria.

The present invention is related to video-coding systems; in particular, the invention relates to an advanced source-coding scheme that enables robust and efficient video transmission.

Emerging multimedia compression standards for image/video coding are evolving towards a multi-resolution (MR) or layered representation of the coded bit-streams. For example, there is a strong push in the next-generation image and video-compression standards—JPEG-2000 and MPEG-4 respectively—to support scalability.

Scalable video coding in general refers to coding techniques that are able to provide different levels or amounts of data per frame of video. Currently, such techniques are used by video-coding standards, such as the MPEG-1 MPEG-2 and the MPEG-4 (i.e., Motion Picture Experts Group), in order to provide flexibility when outputting coded video data. While MPEG-1 and MPEG-2 video-compression techniques are restricted to rectangular pictures from a natural video, the scope of an MPEG-4 visual is much wider. An MPEG-4 visual allows both a natural and a synthetic video to be coded and provides content-based access to individual objects in a scene.

The underlying assumption or design starting point for scalable-coding schemes is that unequal error protection can be applied to the different video bit-stream layers to guarantee a minimum bit rate and loss rate for the base layer, and other less desirable sets of bit-rate and loss rate for the higher layers. This assumption is valid in many networks such as an in-door wireless LAN, or the future Internet with differentiated services, but it is invalid or non-optimal in many other types of networks such as multiple antennae-transmission systems or the Internet where a diverse set of paths, each with its own bottleneck, exists between the sender and the receiver. This therefore underlines the need for an efficient mechanism to create multiple descriptions of compressed video that can be efficiently mapped to networks with path diversity.

Multiple-Description (MD) source coding has emerged recently as an alternative framework for robust transmission over multiple channels with equal and uncorrelated error characteristics. Examples of such channels are found in best-effort heterogeneous packet networks such as the Internet or multiple antennae-wireless systems.

The basic idea in MD coding is to generate multiple independent descriptions of the source such that each description independently describes the source with certain fidelity, and when more than one description is available, they can be synergistically combined to enhance the reconstructed source quality. Most of the prior work on MD coding has been restricted to source coding-based approaches, such as an MD scalar quantizer and transformer with correlation between descriptions. In the video-coding area, most of the MD works have focused on the motion estimation and compensation aspect, hence it is difficult to generalize these approaches to general n-description (n>2) cases. That is, a main drawback from this approach is its lack of scalability to more than two descriptions due to the need to code and send the reference mismatch in each description. Furthermore, the current MDC video-coder structure is very different and more complicated than the current state-of-the-art, video-coding standard such as the MPEG-4, hence the MDC in its current form is unlikely to be accepted widely for many applications in the near future. That is, another drawback is its incompatibility with existing coding standards such as the MPEG and the H.263 or the H.26L for both during encoding and decoding. Thus, a proprietary MD decoder is needed to decode MD-MC bit-streams.

Another area in MDC that are drawing great interest is multiple-description coding using a forward-error-correction code (MD-FEC), which constructs multiple descriptions from layered (scalable) bit-streams. In contrast to the source coding-based methods such as the MD-MC, the MD-FEC employs channel coding to correlate the descriptions, then uses this correlation to generate multiple descriptions with equal priorities.

While the MD-FEC provides a nice framework for transcoding scalable bit streams to multiple descriptions, many of the current video-coding standards employ the motion-compensated prediction and DCT coding (MC-DCT) due to their simplicity as well as efficiency. However, unlike in the image-coding or video-coding cases, the extension of the MD-FEC for the MC-DCT is difficult because the loss of one or more descriptions may introduce temporal prediction drift due to the mismatch of the references used during encoding and decoding.

The present invention addresses the foregoing drift problem by combining the MD-FEC with a multi-layered scalable-coding scheme such as the MPEG-4 Fine Granular Scalability (FGS).

One aspect of the present invention is directed to a simple and efficient way to generate multiple descriptions of compressed video from a multi-layered scalable bit-stream (such as the MPEG-4 FGS) without changing the source-coding operation.

According to another aspect of the present invention, fractional numbers of descriptions can be utilized to reconstruct a video, instead of requiring an integer number of descriptions to reconstruct the video as in the conventional multiple-description coding techniques.

According to yet another aspect of the present invention, the resultant video is drift-free as long as at least one description from whatever channel arrives at the decoder.

One embodiment of the present invention is directed to a method for encoding video data which includes the steps of determining DCT coefficients of the uncoded input video data; coding the DCT coefficients into a base layer bitstream and a enhancement layer bitstream according to a fine-granular scalability coding; converting the base layer bitstream and the enhancement layer bitstream into a plurality of equal priority descriptions; and, decoding the plurality of equal priority descriptions.

Another embodiment of the present invention is directed to a system for processing an input video data. The system includes means for determining DCT coefficients of the input video data; means for coding the DCT coefficients into a base layer and a enhancement layer that include the input video data according to a fine-granular scalability coding; means for converting the base layer and the enhancement layer into a plurality of equal priority descriptions; and, means for decoding at least one of the plurality of equal priority descriptions.

This brief summary has been provided so that the nature of the invention may be understood quickly. A more complete understanding of the invention can be obtained by reference to the following detailed description of the preferred embodiments thereof in connection with the attached drawings.

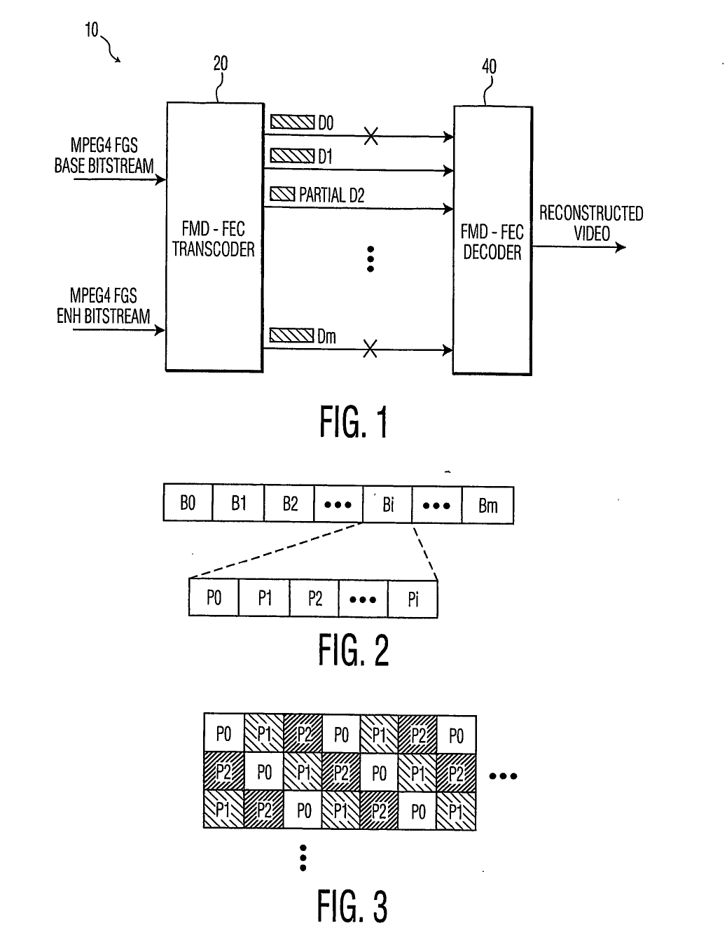

FIG. 1 depicts a video-coding and decoding system in accordance with a preferred embodiment of the present invention.

FIG. 2 depicts a video-packet structure showing the partitioning of MPEG-4 FGS bit-plane units of equal importance in accordance with a preferred embodiment of the present invention.

FIG. 3 depicts a video-packet structure showing the process of splitting a bit plane B2 into three partitions of equal importance in accordance with a preferred embodiment of the present invention.

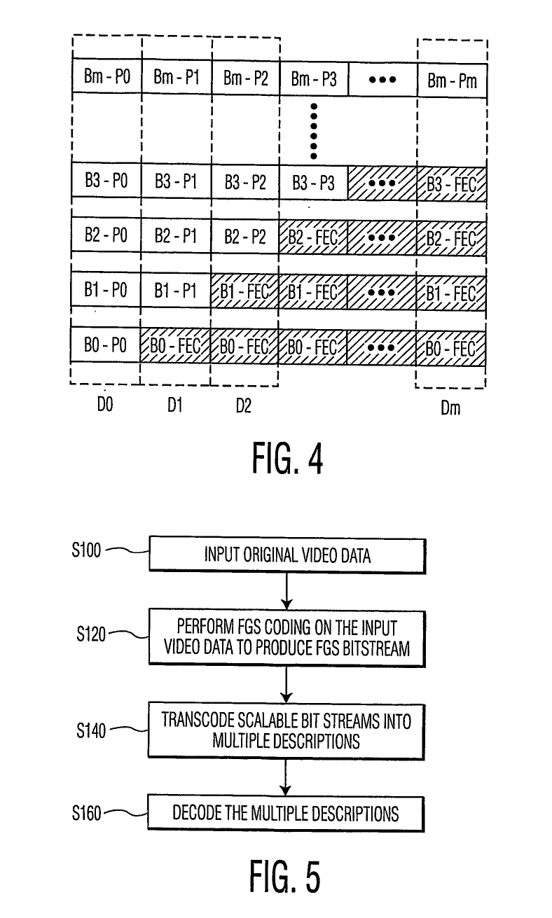

FIG. 4 depicts a construction of multiple descriptions in accordance with a preferred embodiment of the present invention.

In the following description, for purposes of explanation rather than limitation, specific details are set forth such as the particular architecture, interfaces, techniques, etc., in order to provide a thorough understanding of the present invention. However, it will be apparent to those skilled in the art that the present invention may be practiced in other embodiments, which depart from these specific details. For purposes of simplicity and clarity, detailed descriptions of well-known devices, circuits, and methods are omitted so as not to obscure the description of the present invention with unnecessary detail.

In order to facilitate an understanding of this invention, a background of scalable video coding will be described herein.

Scalable video coding is a desirable feature for many multimedia applications and services that are used in systems employing decoders with a wide range of processing power. Scalability allows processors with low computational power to decode only a subset of the scalable video stream. Several video-scalability approaches have been adopted by lead video-compression standards such as the MPEG-2 and the MPEG-4. Temporal, spatial, and quality (i.e., signal-noise ratio (SNR)) scalability types have been defined in these standards. All of these approaches consist of a base layer (BL) and an enhancement layer (EL). The base layer part of the scalable video stream represents, in general, the minimum amount of data needed for decoding that stream. The enhanced layer part of the stream represents additional information, and therefore enhances the video-signal representation when decoded by the receiver.

For example, in a variable bandwidth system, such as the Internet, the base-layer transmission rate may be established at the minimum guaranteed transmission rate of the variable bandwidth system. Hence, if a subscriber has a minimum guaranteed bandwidth of 256 kbps, the base-layer rate may be established at 256 kbps also. If the actual available bandwidth is 384 kbps, the extra 128 kbps of bandwidth may be used by the enhancement layer to improve the basic signal transmitted at the base-layer rate.

For each type of video scalability, a certain scalability structure is identified. The scalability structure defines the relationship among the pictures of the base layer and the pictures of the enhanced layer. One class of scalability is fine-granular scalability (FGS). Images coded with this type of scalability can be decoded progressively. In other words, the decoder may decode and display the image with only a subset of the data used for coding that image. As more data is received, the quality of the decoded image is progressively enhanced until the complete information is received, decoded, and displayed.

The proposed MPEG-4 standard is directed to video-streaming applications based on very low bit-rate coding, such as a video-phone, mobile multimedia/audio-visual communications, multimedia e-mail, remote sensing, interactive games, and the like. Within the MPEG-4 standard, fine-granular scalability (FGS) has been recognized as an essential technique for networked video distribution. FGS primarily targets applications where a video is streamed over heterogeneous networks in real-time. It provides bandwidth adaptivity by encoding content once for a range of bit-rates and enabling the video-transmission server to change the transmission rate dynamically without in-depth knowledge or parsing of the video bit stream.

Many video-coding techniques have been proposed for the FGS compression of the enhancement layer, including wavelets, bit-plane DCT and matching pursuits. The bit-plane coding scheme adopted as reference for FGS includes the following steps at the encoder side, and these coding steps are reversed at the decoder side:
1. residual computation in the DCT domain, by subtracting from each original DCT coefficient the reconstructed DCT coefficient after base-layer quantization and de-quantization;
2. determining the maximum value of all of the absolute values of the residual signal in a video-object plane (VOP) and the maximum number of bits n to represent this maximum value;
3. for each block within the VOP, representing each absolute value of the residual signal with n bits in the binary format and forming n bit-planes;
4. bit-plane encoding of the residual signal absolute values; and,
5. sign encoding of the DCT coefficients, which are quantized to zero in the base layer.

Note that the current implementation of the bit-plane coding of DCT coefficients depends on the base-layer quantization information. The input signal to the enhancement layer is computed primarily as the difference between the original DCT coefficients of the motion-compensated picture and those of the lower quantization cell boundaries used during base-layer encoding (this is true when the base-layer-reconstructed DCT coefficient is non-zero; otherwise zero is used as the subtraction value). The enhancement layer signal, herein referred to as the “residual” signal, is then compressed bit-plane by bit-plane. As the lower quantization cell boundary is used as the “reference” signal for computing the residual signal, the residual signal is always positive, except when the base layer DCT is quantized to zero. Therefore, it not necessary to code the sign bit of the residual signal.

Referring now to FIG. 1, the inventive system 10 of the drift-free Fractional Multiple-Description Joint-Source Channel Coding using Forward-Error-Correction code (FMD-FEC) transcoder 20 and decoder 40 in accordance with a preferred embodiment of the present invention are provided. As described above, the inputs to the transcoder 20 (or server) may be an MPEG4-FGS bit-stream (BASE and ENH layer bit-streams). Here, the input video may be inputted via a network connection, fax/modem connection, a video source, or any type of video-capturing device, an example of which is a digital video camera. The transcoder 20 then converts the input video into equal-priority m+1 descriptions (D0, D1, D2, . . . , Dm). The details of generating multiple descriptions will be explained later in this specification with reference to FIGS. 2-4.

The transcoder 20 transmits the (m+1)-descriptions through (m+1)-distinct channels, then the decoder 40 collects the received descriptions to reconstruct the video. Note that transcoder 30 may transmit only part of a description (i.e., partial D2 in FIG. 1) rather than either transmitting or dropping the whole description during operation. However, according to the coding schemes of the present invention, the decoder 40 is able to recover the input video. For example, if two descriptions, D0 and Dm, were lost but D2 is partially received, the decoder 40 combines all these descriptions, including the fractional description, and generates the best possible video quality out of these full and partial descriptions, as explained hereinafter.

Referring to FIG. 2, if the MPEG4-FGS bit-stream is arranged into a hierarchy of blocks, where B0 denotes the BASE bit-stream and Bi denotes the i-th bit-plane entropy-coded information, Bi has more priority than Bj if i<j due to the nature of the MPEG4-FGS. As such, for all i, Bi is now divided into (m+1) equal-priority partitions P0, . . . , Pi.

Referring to FIG. 3, in MPEG4-FGS cases, the equal-priority partitions can be generated easily by alternatively skipping the bit plane for certain blocks. For example, the entropy-coded information of an 8×8 block at the block location P0 is included in the partition B2-P0, while the block P2 is inserted into the partition B2-P2 and so on. Hence, the contribution of the B2-P0, B2-P1, B2-P2 are orthogonal to each other and have equal priority.

After the partition of each bit plane, the hierarchy of the MPEG4-FGS bit-stream will look like the left upper-corner triangle of FIG. 4. Note that there exist (m+1) equal-priority partitions for each layer Bi, and channel coding fills in the right-bottom corner triangle using a forward-error-correction code (FEC). That is, for the i-th bit-plane or enhancement layer, the FEC codes for Bi can be generated using the ((m+1),(i+1))-Reed Solomon (RS) code. Then for every i, layer Bi has (i+1)+(m+1−(m+1))=(m+1) equal-priority partitions, out of which (i+1) partitions are generated directly from the i-th enhancement layer bit-stream through splitting (partitioning), and the additional (m-i) partitions are generated through an FEC. Each description D0, D1 . . . Dm is then constructed by collecting all partitions across the base and enhancement layers vertically as shown in FIG. 4. Each of the vertically constructed partitions having equal-priority (D0, D1, D2, . . . , Dm), which are converted from the input video by the transcoder 20, is forwarded to the decoder 40.

From the construction of the multiple descriptions, note that if any (k+1)-descriptions are received, then the decoder 40 can decode a video with at least the base layer as well as k-MSB bit planes or k enhancement layers. Furthermore, in the MPEG4-FGS case, the motion-compensation loop operates on the base layer only, hence the reconstructed video is drift-free as long as the decoder 40 always receives at least one description since the base layer is needed for minimum quality.

Unlike conventional multiple-description coding which requires an integer number of descriptions to reconstruct a video, the FMD-FEC allows a fractional number of descriptions as explained in the preceding paragraphs, hence is more flexible in dealing with a large bandwidth fluctuation. More specifically, if the decoder 40 receives two complete descriptions D0 and D1 and a partial description Dm, which only include B0-FEC, B1-FEC and half of B2-FEC while the rest of the information (the other half of B2-FEC, B3-FEC. . . and Bm-Pm) are lost because the server decides to send only part of Dm to meet the throughput drop of the channel m, then the FMD-FEC decoder 40 according to the teachings of the present invention is able reconstruct the B3-P0, B3-P1 and a part of B3-P2 using the partial information of B2-FEC. This is possible as the bit-plane coding is sequential in nature and the FEC is also constructed in the sequential manner as shown in FIG. 4.

In summary, the FMD-FEC according to the embodiment of the present invention can easily generate n descriptions for n>2; does not require the change of the source-coding part and is therefore compliant with existing coding standards; fractional descriptions can be transmitted at the server and decoded at the decoder; and does not have drift as long as at least one description arrives at the decoder.

FIG. 5 is a flow diagram that explains the functionality of the system 100 shown in FIG. 1. To begin, in step S100 the original, uncoded video data is inputted into the system 100. This video data may be inputted via a network connection, fax/modem connection, or a video source. For the purposes of the present invention, the video source can comprise any type of video-capturing device, an example of which is a digital video camera.

Next, step S120 codes the original video data using a technique—i.e., an MPEG-4 FGS encoder—and then splits into Base and Enhancement bit-streams as shown in FIG. 1. In step S140, the received Base and Enhancement bit-streams are converted into a multiple-description (MD) packet stream.

Finally, in step 160, the output of the transcoder 20 is received by a decoder 40, and decoded based on at least one description as the base layer that is needed for minimum quality.

Although the embodiments of the invention described herein are preferably implemented as a computer code, all or some of the steps shown in FIG. 5 can be implemented using discrete hardware elements and/or logic circuits. Also, while the encoding and decoding techniques of the present invention have been described in a PC environment, these techniques can be used in any type of video devices including, but not limited to, digital televisions/settop boxes, video-conferencing equipment, and the like.

In this regard, the present invention has been described with respect to particular illustrative embodiments. It is to be understood that the invention is not limited to the above-described embodiments and modifications thereto, and that various changes and modifications can be made by those of ordinary skill in the art without departing from the spirit and scope of the appended claims.

1. A method of encoding video data comprising the steps of:
receiving input video data;
determining DCT coefficients for the uncoded video data;
coding the DCT coefficients into a base layer bitstream and a enhancement layer bitstream according to a fine-granular scalability coding; and
converting the base layer bitstream and the enhancement layer bitstream into a plurality of equal priority descriptions.

2. The method according to claim 1, further comprising the step of transmitting the converted descriptions layers over different transmission channels.

3. The method according to claim 1, further comprising the step of decoding the plurality of equal priority descriptions.

4. The method according to claim 3, wherein the decoding step is performed based on at least one of the plurality of equal priority descriptions.

5. The method according to claim 1, wherein the plurality of equal priority partitions is comprised of partitions generated from the base and enhancement layer bitstreams and a forward error correction (FEC) code according to predetermined criteria.

6. An apparatus for coding an input video comprising:
a memory which stores computer-executable process steps; and
a processor which executes the process steps stored in the memory so as (i) receive a base layer and an enhancement layer that include an input video data encoded according to a fine-granular scalability coding, (ii) to convert the base layer and the enhancement layer into a plurality of equal priority descriptions, (iii) to transmit the converted equal priority descriptions over different transmission channels.

7. The apparatus according to claim 6, further comprises means for decoding at least one the plurality of equal priority descriptions.

8. The apparatus according to claim 7, wherein the decoding means is an MPEG4decoder.

9. The apparatus according to claim 6, wherein the plurality of equal priority partitions is comprised of partitions generated from the base and enhancement layers and a forward error correction (FEC) code.

10. The apparatus according to claim 6, wherein the plurality of equal priority partitions is generated from the base and enhancement layers and a forward error correction (FEC) code.

11. A system for processing an input video data, the apparatus comprising:
means for determining DCT coefficients of the input video data;
means for coding the DCT coefficients into a base layer and a enhancement layer that include the input video data according to a fine-granular scalability coding; and
means for converting the base layer and the enhancement layer into a plurality of equal priority descriptions.

12. The system according to claim 11, further comprising means for transmitting at least one of the plurality of equal priority descriptions layers over different transmission channels.

13. The system according to claim 11, further comprising means for decoding at least one of the plurality of equal priority descriptions.

14. The system according to claim 11, wherein the plurality of equal priority partitions is comprised of partitions generated from the base and enhancement layers and a forward error correction (FEC) code according to predetermined criteria.

15. The system according to claim 13, wherein the decoding means is an MPEG-4 decoder.
